(19) United States
(12) Patent Application Publication
(10) Pub. No.: US 2012/0067522 A1
(43) Pub. Date: Mar. 22, 2012

(54) VACUUM PROCESSING APPARATUS

(75) Inventors: Takahiro Shimomura, Kudamatsu (JP); Yutaka Kudou, Kudamatsu (JP); Masakazu Isozaki, Shunan (JP); Takashi Uemura, Kudamatsu (JP)

(73) Assignee: HITACHI HIGH-TECHNOLOGIES CORPORATION

(21) Appl. No.: 13/022,232

(22) Filed: Feb. 7, 2011

(30) Foreign Application Priority Data
Sep. 21, 2010 (JP) 2010-210355
Dec. 28, 2010 (JP) 2010-291535

(51) Int. Cl. C23F 1/08; B05C 13/00; B05C 11/00

(52) U.S. Cl. 156/345.32; 118/50; 156/345.37

(57) ABSTRACT

A vacuum processing apparatus having an atmospheric-pressure transport chamber for conveying samples, lock chambers that accommodate the samples conveyed in and have an ambient capable of being switched between an atmospheric ambient and a vacuum ambient, a vacuum transport chamber coupled to the lock chambers, and at least one vacuum chamber for processing the samples. The apparatus further includes cooling portions operable to cool the high-temperature samples processed by the vacuum chamber. Each cooling portion has: a sample stage over which the high-temperature samples are placed and which has a coolant channel; gas-blowing tubes disposed closer to the inlet/exit port and acting to blow gas toward the sample stage; and an exhaust port disposed on the opposite side of the sample stage with regard to the inlet/exit port and acting to discharge the gas blown from the gas-blowing tubes.

### INCORPORATION BY REFERENCE

The present application claims priorities from Japanese applications JP2010-210355 filed on Sep. 21, 2010, JP2010-291535 filed on De. 28, 2010, the content of which is hereby incorporated by reference into this application.

### BACKGROUND OF THE INVENTION

The present invention relates to a vacuum processing apparatus for transporting substrates to be processed (including wafers and samples in the form of substrates and hereinafter simply referred to as wafers) between a vacuum chamber and a cassette and, more particularly, to a vacuum processing apparatus in which high-temperature wafers processed by vacuum chambers are cooled in a cooling station and then returned into a cassette.

The following patent documents are cited as prior art references pertinent to the invention of the subject application:

### Patent Document 1, JP-A-2002-280370

### Patent Document 2, JP-A-2007-95856

### Patent Document 3, JP-A-2009-88437

### Patent Document 4, JP-A-11-102951

Processing steps for fabricating semiconductor devices include high-temperature processing steps such as film deposition step and ashing step. During these steps, wafers processed at high temperatures (about 100° C. to 800° C.) must be transported. Therefore, there is the problem that concentration of thermal stress due to rapid temperature variations produces cracks on end and rear surfaces of wafers. This induces wafer breakages or excessive heating of the cassette accommodating the wafers due to heat brought in by the wafers with consequent degassing of organic gases from the cassette. The gases may adhere to the wafers. In an extreme case, the cassette is thermally deformed.

Usually, processed wafers are accommodated in slots of cassettes where unprocessed wafers are also received. Depending on the temperature of the accommodated wafers and on the adherends adhered to the wafers, reactive gases are released from the wafer surfaces. The released gases adhere to unprocessed wafers in the same cassette and thus adhere to the front and rear surfaces of the wafers as microscopic foreign materials produced by surface reactions or vapor phase reactions. This may give rise to foreign matter or pattern defects. If they adhere even at a gas level, they may become a factor causing a decrease in electrical yield provided that they are contaminants, thus presenting problems. A technique for solving these problems is disclosed in Patent Document 1. In particular, wafers processed at high temperatures are conveyed into a cooling mechanism while kept placed on a transfer robot capable of supporting such plural wafers. Furthermore, Patent Document 2 discloses a technique for suppressing foreign matter on unprocessed wafers by accommodating unprocessed and processed wafers in separate cassettes. Patent Document 3 discloses a technique of preventing adhesion of foreign matter and formation of native oxide film by blowing inert gas against processed wafers from gas injection tubes mounted at the inlet/exit port of each cassette to provide gas displacement. In addition, Patent Document 4 discloses a technique consisting of cooling high-temperature wafers in two stages respectively in a vacuum created in a preliminary vacuum chamber and in atmosphere down to a temperature where a closed cassette is no longer thermally deformed.

However, in a vacuum processing apparatus having a vacuum chamber, in a case where high-temperature wafers are cooled on the vacuum side down to a temperature at which the cassette is not thermally deformed and returned to the cassette by applying any one of the above-described conventional techniques, it takes time to cool the wafers and delays transportation of the processed wafers, thus deteriorating the processing efficiency of the vacuum processing apparatus. Additionally, in recent years, semiconductor devices have been required to have stricter values concerning foreign matter and metal contamination to achieve further miniaturization of semiconductor devices. Reduction of foreign materials of less than 50 nm has been essential. At the same time, it has become important to reduce, suppress, or avoid adhesion of microscopic foreign materials to unprocessed and processed wafers, as well as gas contamination. These problems are common between the vacuum processing apparatus for providing two-stage cooling in a vacuum and in atmosphere and the vacuum processing apparatus providing cooling mainly in atmosphere.

### SUMMARY OF THE INVENTION

In view of these problems, the present invention has been made. It is an object of the invention to provide a vacuum processing apparatus capable of efficiently cooling wafers, which have been processed at high temperatures in vacuum chambers, down to a temperature at which microscopic foreign materials and contamination present no problems.

The present invention provides a vacuum processing apparatus comprising a cassette stage on which a cassette having plural samples accommodated therein is placed, an atmospheric-pressure transport chamber for conveying the samples, lock chambers that accommodate the samples conveyed in from the atmospheric-pressure transport chamber and have an ambient capable of being switched between an atmospheric ambient and a vacuum ambient, a vacuum transport chamber coupled to the lock chambers, and at least one vacuum chamber for processing the samples conveyed in via the vacuum transport chamber. Cooling units for cooling the high-temperature samples processed by the vacuum chamber are disposed in the atmospheric-pressure transport chamber. Each of the cooling units has sample stages, gas-blowing tubes disposed on a side of an inlet/exit port of the cooling unit through which the samples are conveyed in and out and acting to blow gas toward the sample stages, and an exhaust port disposed on the opposite side of the sample stages with regard to the inlet/exit port and acting to exhaust the gas blown from the gas-blowing tubes. The high-temperature samples are placed over the sample stages, which are provided with a coolant channel.

The configuration of the present invention makes it possible to efficiently cool wafers which have been processed at high temperatures in vacuum chambers.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic representation of a vacuum processing apparatus associated with Embodiment 1 of the present invention, showing the structure of the apparatus;

FIG. 2 is a side elevation in cross section of a cooling station 6;

FIG. 3 is a front elevation in cross section of the cooling station 6;

FIG. 4 is a schematic representation of a sample stage 15, showing its structure;

FIG. 5 is a view illustrating locations at which purge members 11 are installed;

FIG. 6 is a cross-sectional view showing the shape of one purge member 11;

FIG. 7 is a graph showing a correlation between the temperature of each wafer 8 and the time for which the wafer 8 is cooled;

FIG. 8 is a graph showing the results of measurement of the concentration of gas released from the surface of each wafer 8; and

FIG. 9 is a schematic representation of a vacuum processing apparatus associated with Embodiment 2 of the invention, showing the structure of the apparatus.

### DESCRIPTION OF THE EMBODIMENTS

### Embodiment 1

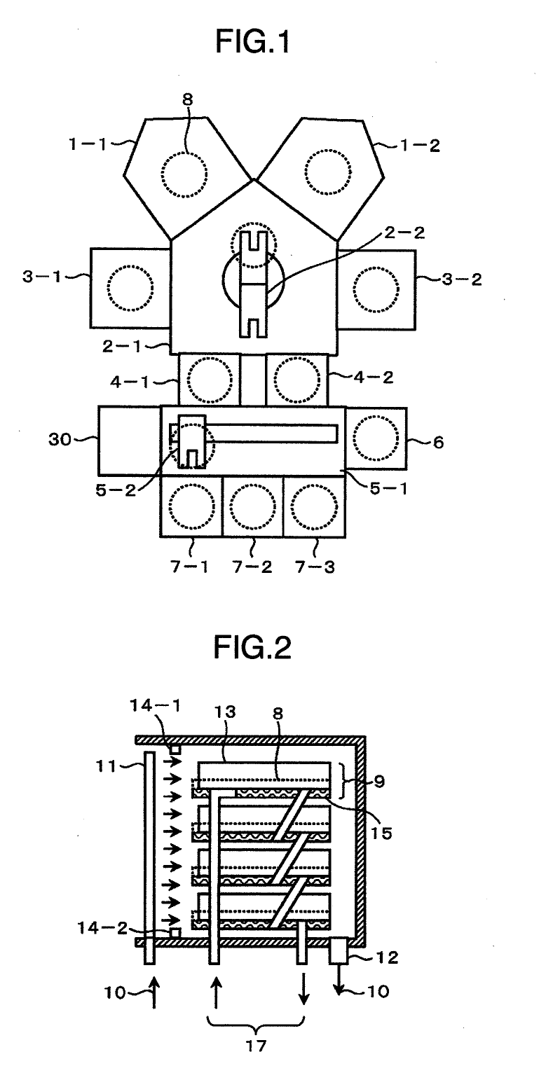

Embodiment 1 of the present invention is hereinafter described with reference to FIGS. 1-8.

FIG. 1 is a schematic representation of a vacuum processing apparatus associated with Embodiment 1 of the present invention, showing the structure of the apparatus. In the present embodiment, an example is taken in which ashing is performed in vacuum chambers.

The vacuum processing apparatus is designed including plural ashing units 1 (1-1 and 1-2) for performing ashing processes, a vacuum transport chamber 2-1 provided with a first transfer robot 2-2 for transporting wafers 8 into the ashing units 1 in a vacuum and performing other processing steps, cooling units 3 (3-1 and 3-2) being first cooling mechanisms connected with the vacuum transport chamber 2-1, lock chambers 4 (4-1 and 4-2) capable of being switched between an atmospheric ambient and a vacuum ambient to transport the wafers 8 in and out, an atmospheric-pressure transport unit 5-1 equipped with a second transfer robot 5-2 for transporting the wafers out of and into the lock chambers 4, a cooling station 6 being a second cooling mechanism coupled to the atmospheric-pressure transport unit 5-1, and a cassette stage (not shown) which is located within the atmospheric-pressure transport unit 5-1 and over which cassettes 7 (7-1, 7-2, and 7-3) having the wafers 8 accommodated therein are placed.

The wafers 8 ashed by the ashing units 1 at a high temperature of about 300° C. are conveyed by the first transfer robot 2-2 into the cooling units 3 (first cooling mechanisms), where the wafers 8 are cooled to about 100° C. (in particular, from 90° C. to 110° C.). The cooling temperature achieved by the cooling units 3 is set to about 100° C. to suppress adhesion of atmospheric moisture to the surfaces of the wafers 8 when exposed to the atmosphere and to avoid the processing efficiency of the ashing units 1 from deteriorating due to prolongation of the time taken to cool the wafers 8, which have been heated to about 300° C., to a temperature at which the wafers can be returned to the cassettes 7. The wafers 8 cooled to about 100° C. are conveyed by the first transfer robot 2-2 from the cooling units 3 into the lock chambers 4, where the wafers are purged in an atmospheric ambient. Then, the wafers are transported to the cooling station 6 by the second transfer robot 5-2.

A plurality of slots 9 for accommodating and cooling the wafers 8 transported in is provided in the cooling station 6. A sample stage 15 through which coolant is circulated such that the stage is controlled to a desired temperature is mounted in each slot 9. Each wafer 8 conveyed by the second transfer robot 5-2 is received in any one of the slots 9 where no wafer 8 is accommodated, and is maintained in close proximity to the stage 15 for 10 to 70 seconds so that the wafer 8 is cooled to 30° C. or room temperature (25° C.), which is approximate to the temperature of unprocessed wafers 8 in the cassettes 7 and intended to bring the interior of the cassettes 7 into the same environment as the interior of unprocessed cassettes 7 at all times even if processed wafers 8 and unprocessed wafers 8 are mixed. Each wafer 8 is maintained in close proximity to the stage 15 to prevent the rear surface of the wafer 8 from contacting the stage. In the present embodiment, vacuum suction pads 18 are installed to maintain the gap between the wafer and the stage. This can suppress scratches on the end and rear surfaces of the wafer 8 and therefore breakage of the wafer 8 can be suppressed. Furthermore, adhesion of foreign materials to the end and rear surfaces of the wafer 8 can be prevented. In addition, the surfaces can be prevented from being contaminated.

Purge members 11 are mounted in the inlet/exit port of the cooling station 6 (second cooling mechanism) through which the wafers 8 can be conveyed in and out. Simultaneously with start of a cooling process in the cooling station 6, clean dry air 10 is blown into the slots 9 from the purge members 11. The air is discharged into an exhaust port 12 formed on the opposite side of the purge members 11 and in a lower portion of the depth of the cooling station. The cooling process is started when lot processing is commenced but the starting of the cooling process is not limited to start of lot processing. The cooling process may be started when wafers 8 are conveyed over the stages 15 or when already ashed wafers 8 are conveyed into the lock chambers 4. The lot processing means that all or a prescribed number of wafers 8 accommodated in at least one cassette 7 are processed.

Then, the wafers 8 cooled to 30° C. or room temperature (25° C.) are taken out of the cooling station 6 by the second transfer robot 5-2 in the atmospheric-pressure transport unit 5-1 and accommodated into the cassettes 7, thus completing the processing of the wafers 8. The operations described so far are repeated until ashing of all the wafers 8 previously received in the cassettes 7 is completed. The cooling process of the vacuum processing apparatus is under control of a controller 30.

The aforementioned two-stage cooling of the heated wafers 8 on the vacuum side and on the atmospheric side by the vacuum processing apparatus can suppress concentration of thermal stress in the wafers 8 due to rapid temperature variations without deteriorating the efficiency of ashing performed by the ashing units 1. Therefore, contamination due to gases released from the cassettes 7 (degassing) by the heat brought in from the wafers 8 and thermal deformation of the cassettes 7 can be prevented. Consequently, efficient ashing process and efficient cooling process can be achieved at the same time.

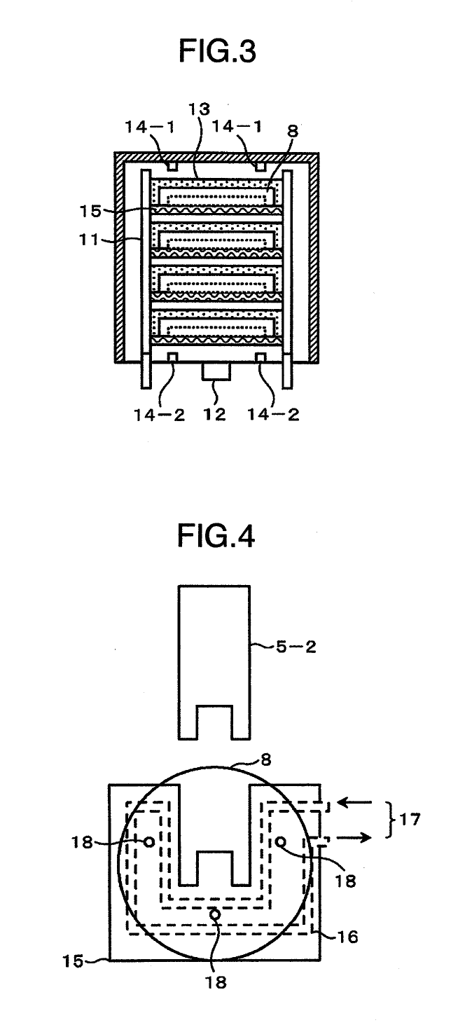

The configuration of the cooling station 6 is described by referring to FIGS. 2 and 3. FIG. 2 is a side elevation in cross section of the cooling station 6. FIG. 3 is a front elevation in cross section of the cooling station 6. The cooling station 6 comprises the slots 9 having the stages for cooling the wafers processed at high temperatures, the purge members 11 being gas-blowing tubes for ejecting the clean dry air 10 to remove the gases released from the wafers and to prevent the reactive gases emitted from the surfaces of the wafers 8 from entering the atmospheric-pressure transport unit 5-1 and the interior of each cassette 7, and the exhaust port 12 for exhausting the clean dry air 10 ejected from the purge members 11. Inert gas such as nitrogen gas, argon gas, or helium gas may be ejected instead of the clean dry air 10.

The number of the slots 9 mounted inside the cooling station 6 is set equal to or greater than the number of the ashing units 1 to prevent the efficiency of ashing process and the cooling efficiency of the cooling units (first cooling mechanisms) from deteriorating. Since the slots can be assigned respectively to the ashing units 1 and this assignment can be held, the wafers 8 ashed by the ashing units 1 and contaminated can be prevented from being received in other than the previously assigned slots. In consequence, cross contamination can be prevented. In the present embodiment, there are two ashing units 1, while there are four slots 9. In the cooling station 6, the slots 9 are stacked in the vertical direction.

The slots 9 are partitioned from each other by covers 13. Each cover 13 is designed to have an opening on the front side through which the wafers 8 are conveyed in to prevent the clean dry air 10 blown by the purge members 11 within the slots 9 from stagnating inside the slots 9. Because of this structure, the slots 9 are spatially isolated from other wafers 8. As a consequence, gaseous components produced from the surfaces of the wafers 8 can be expelled out of the atmospheric-pressure transport unit 5-1 by ejection of the above-described clean dry air 10 or inert gas (such as nitrogen gas, argon gas, or helium gas), thus preventing the gaseous components from adhering to other wafers 8.

The position at which each wafer 8 is held relative to the second transfer robot 5-2 of the atmospheric-pressure transport unit 5-1 shifts with increasing the number of transfers of the wafers 8 (i.e., with the elapse of time). As a result, when each wafer 8 is received in the cassette 7, the wafer 8 will contact either the inlet/exit port of the cassette 7 through which the wafer 8 is transported in and out or the slots in the cassette 7. This produces foreign matter, which will adhere to the wafer 8. In extreme cases, there is the possibility that the wafer 8 breaks or becomes chipped. Therefore, sensors are mounted as follows to detect the position of the wafer 8 immediately after the wafer 8 is taken out of the cooling station 6 by the second transfer robot 5-2 and to make a decision as to whether the wafer 8 can be safely received in the cassette 7.

As shown in FIGS. 2 and 3, in order to monitor the position of each wafer 8, two projected light sensors 14-1 and two light-receiving sensors 14-2 are installed in the inlet/exit port of the cooling station 6 through which the wafer 8 can be transported in and out. The projected light sensors 14-1 are spaced apart left and right at a higher position. The light-receiving sensors 14-2 are spaced apart left and right at a lower position. Since light incident on the light-receiving sensors 14-2 is blocked, the position of the wafer 8 is detected and monitored. Thus, abnormality such as breakage of the wafer 8 is prevented. When the wafer 8 is conveyed in or out, if the wafer 8 has shifted, the cooling process can be instantly stopped. As a result, breakage of the wafer 8 and contact of the wafer 8 with the cassette 7 or other component can be prevented or avoided. Furthermore, when the wafer 8 is conveyed in or out, if the wafer 8 has shifted, it is possible to cope with the shift by correcting the operation of the second transfer robot 5-2 for accommodating the wafer 8 or correcting the positional deviation of the wafer 8 by means of an alignment mechanism (not shown).

The sample stage 15 over which the wafer 8 is placed such that the wafer is kept in close proximity to the stage to cool the wafer 8 is described by referring to FIG. 4.

The sample stage 15 has been cut out into the same shape as a holding portion (not shown) of the second transfer robot 5-2 that holds the wafer 8, the robot 5-2 being installed in the atmospheric-pressure transport unit 5-1. A coolant channel 16 for cooling the wafer 8 is formed in the stage 15 as shown in FIG. 4. The wafer is cooled to a desired temperature by circulating cooling water 17 (such as room-temperature water) through the coolant channel 16. The coolant circulated through the channel 16 may be temperature-controlled by a temperature control unit (not shown), in which case cooling can be done at a higher rate than when normal-temperature water is used because the temperature of the coolant can be set at will.

Regarding the time for which the wafer 8 over the stage 15 is cooled, any arbitrary time can be entered as a parameter of a recipe specifying cooling process conditions for the cooling process performed in the cooling station 6. By making the shape of the stage 15 identical with the shape of the holding portion of the second transfer robot 5-2 that holds the wafer 8, an operation of a pusher mechanism to receive and deliver wafers 8 as often used in the prior art can be dispensed with. The wafer 8 can be directly conveyed over the stage 15 from the second transfer robot 5-2. This can contribute to a cost saving of the vacuum processing apparatus and an improvement of the throughput.

In the prior art, when the wafer 8 is placed on the sample stage 15, shift of the wafer 8 has been avoided by mounting guide members. In recent years, generation of foreign matter from an outer peripheral portion of the wafer 8 has presented problems because the peripheral portion makes contact with the guide members. In the present embodiment, therefore, a stage structure not equipped with guide members for holding the wafer 8 is adopted to reduce the contact between the outer peripheral portion of the wafer 8 and the wafer-holding portion.

Therefore, when the set flow rate of the clean dry air 10 ejected from the purge members 11 is not sufficiently adjusted, the wafer 8 conveyed into the stage 15 may deviate out of position over the surface of the stage. To prevent such deviation of the wafer 8, the vacuum suction pads 18 are mounted in the position of the surface of the stage 15 in which the wafer 8 is placed, in order to suck the wafer 8.

The vacuum suction pads 18 on which a sample is placed is made of a resinous material such as fluororubber, Teflon™, or polyimide resin. As shown in FIG. 4, the pads are placed at three locations on the stage 15 where the wafer 8 is placed, and have a height of 0.5 mm. Deviation of the wafer 8 can be prevented by vacuum suction using the vacuum suction pads 18 without the need to take account of the effects of the flow rate of the clean dry air 10 ejected from the purge members 11. In addition, the area of contact between the rear surface of the wafer 8 and the stage 15 can be reduced greatly. Hence, adhesion of foreign matter to the rear surface of the wafer 8 and contamination of the rear surface can be prevented. Further, the vacuum suction can be manually switched between activation mode (ON) and deactivation mode (OFF).

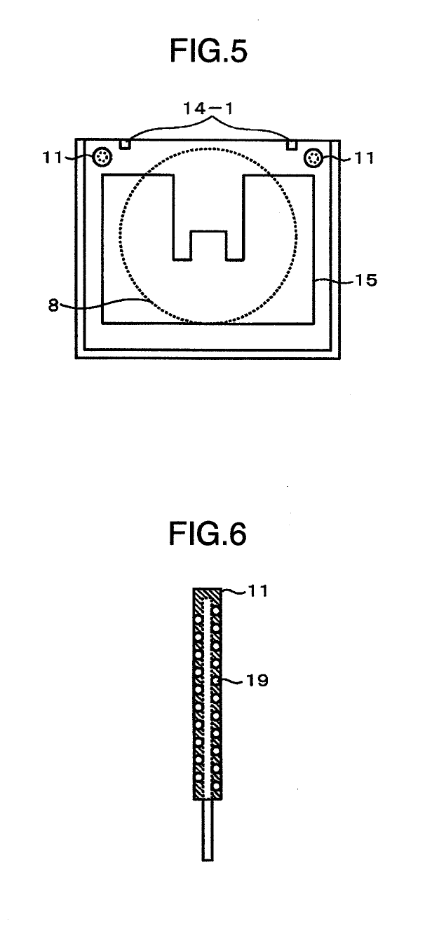

FIG. 5 shows the locations at which the purge members 11 are installed. FIG. 6 shows the shape of one purge member 11.

As shown in FIG. 3, the purge members 11 are spaced apart left and right in the inlet/exit port of the cooling station 6 through which the wafer 8 can be conveyed in and out. The members are so positioned that they do not interfere with the operation of the second transfer robot 5-2 for conveying in and out the wafer 8. The purge members 11 extend perpendicular to the slots 9.

The shape of the purge members 11 is next described. Each purge member 11 assumes the form of a hollow cylinder and has the same length as four stages of slots 9. Ejection holes 19 for ejecting the clean dry air 10 or inert gas (such as nitrogen gas, argon gas, or helium gas) are formed uniformly both longitudinally (vertical direction) and peripherally. The arrangement of the ejection holes 19 is not limited to the above-described arrangement. In the longitudinal direction, the ejection holes 19 may be located close to positions opposite to the stage 15. In the peripheral direction, they may be located opposite to the slots 9. The height of the slots 9 is not limited to the length equal to four stages of slots. The height may be determined according to the number of stages of slots. The number of stages of the slots 9 is equal to or greater than the number of vacuum chambers (in the present example, the ashing units 1).

The clean dry air 10 or inert gas (such as nitrogen gas, argon gas, or helium gas) is blown against the slots 9 from the ejection holes 19 to purge the wafer 8. Gases released from the wafer 8 are forced into the exhaust port 12 that is formed in the bottom surface on the opposite side of the inlet/exit port of the cooling station 6 through which the wafer 8 is conveyed in and out such that the gases do not stagnate within the slots 9. Consequently, gases adhering to the surfaces of the wafer 8 can be eliminated. It is possible to prevent the gases produced from the surfaces of the wafer 8 from flowing into the atmospheric-pressure transport unit 5-1 or into the cassette 7.

The cooling effects on the wafer 8 can be enhanced by ejecting the clean dry air 10 or inert gas (such as nitrogen gas, argon gas, or helium gas) from the purge members 11. The gases released from the wafer 8 are eliminated by positively exhausting the clean dry air 10 or inert gas from the purge members 11 into the exhaust port 12. The effects on the already cooled wafer 8 can be prevented by suppressing reverse flow of the gases into the atmospheric-pressure transport unit 5-1 and suppressing the gases released from the wafers 8 in other slots 9 from entering the slots 9 in the cooling station 6. Because the wafer 8 is cooled down to a temperature at which degassing of the wafer 8 no longer occurs in the cooling station 6 and then the wafer 8 is returned to the cassette 7, adhesion of minute foreign materials to unashed wafers 8 within the same cassette 7 also holding the cooled wafer 8 can be suppressed.

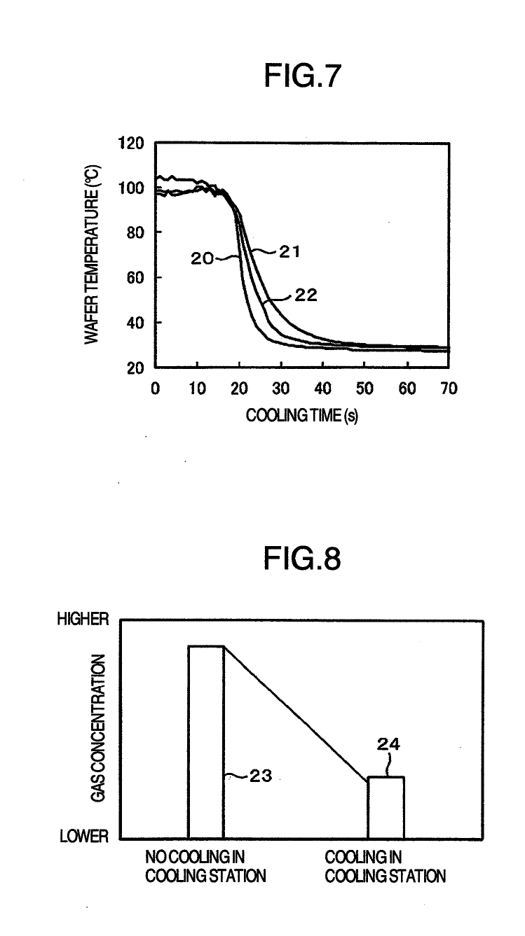

FIG. 7 is a graph showing the results of an examination using the vacuum processing apparatus of the present invention to find a correlation between the temperature of each wafer 8 and the cooling time.

In one ashing unit 1, an electric discharge was carried out for 60 seconds using oxygen gas at an ashing stage temperature of 300° C. by using a silicon wafer 8. Then, the wafer was cooled down to about 100° C. by one cooling unit 3 and carried onto or over the sample stage 15 within the cooling station 6. In one case, the wafer 8 was brought into contact with the surface of the stage 15. In another case, the wafer 8 was maintained in close proximity to the surface. In a further case, the clean dry air 10 was blown against the wafer 8 while maintaining it in close proximity to the stage. In these cases, the correlation between the time for which the silicon wafer 8 was cooled and the temperature of the wafer 8 was examined.

The conditions under which cooling was done in the cooling station 6 and the result was evaluated were as follows. The temperature of the stage 15 was set to 25° C. (room temperature). The stage 15 was cooled for 70 seconds. Regarding evaluation of cooling done under the condition where the wafer 8 was brought to contact with the surface of the stage 15, the vacuum suction pads 18 were removed. Under this condition, the rear surface of the silicon wafer 8 was brought into contact with the whole surface of the stage 15. In this state, the cooling was evaluated.

In FIG. 7, curve 20 indicates the case in which the wafer 8 was kept in contact with the stage 15 (herein referred to as the contact mode), while curve 21 indicates the case in which the wafer was kept in close proximity to the stage (herein referred to as the proximity mode). In the proximity mode (21), the cooling time was longer. Where the clean dry air 10 was blown against the wafer while it was kept in close proximity to the stage (herein referred to as the proximity-and-blowing mode), the resulting characteristic curve is indicated by 22. In the proximity-and-blowing mode (22), the cooling time could be improved compared with the proximity mode (21) and was closer to the contact mode (20). Visual inspection has shown that no scratches were present on the rear surface of the wafer 8. The result arises from the fact that the gases released from the high-temperature wafer 8 were exhausted and the wafer 8 was cooled by blowing the clean dry air 10 against the wafer. This has demonstrated that sufficient cooling performance and suppression of scratches on the wafer rear surface can be both achieved by the proximity holding of the present embodiment and the purging using the clean dry air 10.

The concentrations of gas released from the surfaces of wafers 8 were measured using the ashing units 1 at various temperatures of the wafers 8. The results are next described.

An electric discharge was carried out in the ashing unit 1 for 60 seconds using oxygen gas at an ashing stage temperature of 300° C. by using a resist wafer 8. Then, the wafer was cooled down to about 100° C. by one cooling unit 3. In one case, the wafer was accommodated in the cassette 7. In another case, the wafer was cooled down to about 100° C. by the cooling unit as described above, the wafer was then cooled below 30° C. using the cooling station 6, and the wafer was accommodated in the cassette 7. In each case, the concentration of gas released from the surface of the resist wafer 8 in the cassette 7 was measured.

In the above-described measurements, cooling was done in the cooling station 6 under the following conditions. The temperature of the stage 15 was set to 25° C. (room temperature). The wafer 8 was maintained in close proximity to the stage 15. The cooling was performed for 70 seconds. The clean dry air 10 was blown against the wafer 8 from the purge members 11.

When resist wafers 8 were intact accommodated in cassettes 7 without using the cooling station 6, the concentrations of gas released from the surfaces of the resist wafers 8 were found to be high as indicated by 23 as a result of measurements as shown in FIG. 8. In contrast, when resist wafers 8 were sufficiently cooled close to 30° C. in the cooling station 6, the concentrations of gas released from the surfaces of the resist wafers 8 were found to be low as indicated by 24.

These results show that the amount of gases released from the surfaces of the wafers 8 and the amount of organic gases from the cassettes 7 due to degassing can be suppressed by using the cooling unit 3 and the cooling station 6 and lowering the temperatures of the wafers 8 in a stepwise manner.

Adhesion of foreign materials of less than 50 nm to the unashed wafer 8 within the cassette 7 was confirmed. To evaluate the foreign materials, resist wafers 8 for performing a continuous ashing process were placed on the first through 24th stages in the same cassette 7. A silicon wafer 8 for foreign material measurement was placed on the 25th stage.

In the same way as in the above-described gas concentration comparison experiments, an electric discharge was conducted on the resist wafers 8 on the first through twenty-fourth stages for 60 seconds using oxygen gas at an ashing stage temperature of 300° C. on the ashing unit 1. The wafers were cooled down to about 100° C. with the cooling unit 3. Then, in one case, wafers were intact accommodated in the cassettes 7 while keeping the temperature at about 100° C. In another case, wafers were cooled below 30° C. in the cooling station 6 and accommodated in the cassettes 7. In either case, the wafers were then allowed to stand for a given time within the cassettes 7. It was confirmed that there was an increase in the number of foreign materials on the silicon wafer 8 on the 25th stage for foreign material measurement.

As a result, where no cooling was performed in the cooling station 6, the number of increase of foreign materials of less than 50 nm was as many as 3,782. In contrast, where cooling was done in the cooling station 6, the number of increase of foreign materials of less than 50 nm could be reduced to about one third (1,061).

These results indicate that the number of foreign materials adhering to each wafer 8 can be reduced by the use of the cooling unit 3 and the cooling station 6 and lowering the temperature of the wafer 8 in a stepwise fashion.

In the present embodiment, the processing performed in each vacuum chamber was an ashing process. The present embodiment is also effective in other high-temperature processing such as plasma etching and CVD, in which case the same advantages as the advantages of the present embodiment can be obtained.

### Embodiment 2

A vacuum processing apparatus associated with Embodiment 2 of the present invention is next described.

Since the structure of the vacuum processing apparatus associated with the Embodiment 2 has the same components as their counterparts of the structure of the vacuum processing apparatus associated with Embodiment 1, the same components are indicated by the same reference numerals and their description is omitted.

In Embodiment 1, both cooling units 3 and cooling station 6 are used, and the temperature of each wafer 8 is lowered in a stepwise manner. The present embodiment is characterized in that cooling is done using only the cooling station 6.

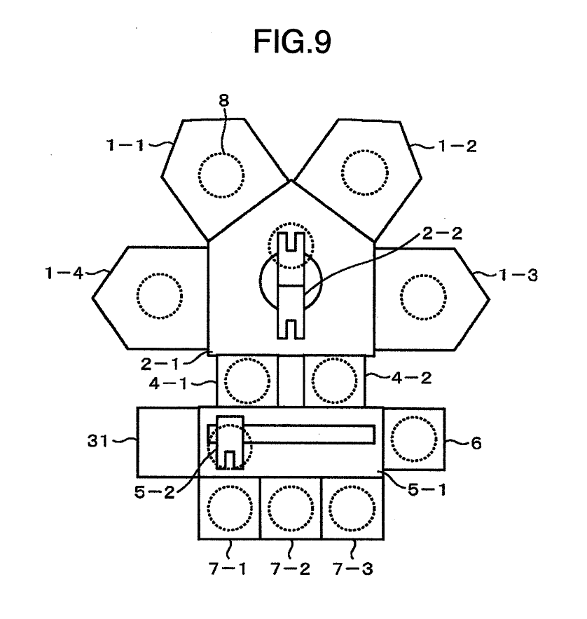

FIG. 9 is a schematic representation of a vacuum processing apparatus of the present embodiment, showing the structure of the apparatus. In the present embodiment, an ashing processes are performed in vacuum chambers.

The vacuum processing apparatus is designed including plural ashing units 1 (1-1, 1-2, 1-3, and 1-4) for performing ashing processes, a vacuum transport chamber 2-1 provided with a first transfer robot 2-2 for transporting wafers 8 into the ashing units 1 in a vacuum and performing other processing steps, lock chambers 4 (4-1 and 4-2) capable of being switched between an atmospheric ambient and a vacuum ambient to transport the wafers 8 in and out, an atmospheric-pressure transport unit 5-1 equipped with a second transfer robot 5-2 for transporting the wafers out of and into the lock chambers 4, a cooling station 6 being a cooling portion coupled to the atmospheric-pressure transport unit 5-1, and a cassette stage (not shown) which is located within the atmospheric-pressure transport unit 5-1 and over which cassettes 7 (7-1, 7-2, and 7-3) having the wafers 8 accommodated therein are placed.

Each wafer 8 ashed at a high temperature of about 300° C. by any one of the ashing units 1 is conveyed by the first transfer robot 2-2 into any one lock chamber 4, where the wafer is purged within an atmospheric ambient. Then, the wafer is conveyed into the cooling station 6 by the second transfer robot 5-2.

A plurality of slots 9 for accommodating and cooling the wafer 8 conveyed in is provided in the cooling station 6. A sample stage 15 through which coolant is circulated to maintain the stage at a desired temperature is mounted in each slot 9. The wafer 8 conveyed in by the second transfer robot 5-2 is accommodated into any one slot 9 where no wafer 8 has been received. The accommodated wafer is maintained in close proximity to the stage 15 for 50 to 200 seconds. As a result, the wafer 8 is cooled down to 30° C. or room temperature (25° C.), which is approximate to the temperature of unprocessed wafers 8 in the cassettes 7 and intended to bring the interior of the cassettes 7 into the same environment as for unprocessed cassettes 7 at all times even if processed wafers 8 and unprocessed wafers 8 are mixed. The aforementioned wafer 8 is maintained in close proximity to the stage 15 with a gap therebetween to prevent the rear surface of the wafer 8 from contacting the stage. In the present embodiment, vacuum suction pads 18 are installed to hold the wafer in close proximity to the stage. This can suppress scratches on the end and rear surfaces of the wafer 8 and therefore breakage of the wafer 8 can be suppressed. Furthermore, adhesion of foreign materials to the end and rear surfaces of the wafer 8 and contamination can be prevented.

Purge members 11 are mounted in the inlet/exit port of the cooling station 6 (cooling portion) through which each wafer 8 can be conveyed in and out. Simultaneously with start of a cooling process in the cooling station 6, clean dry air 10 is blown into the slots 9 from the purge members 11. The air is discharged into an exhaust port 12 formed on the opposite side of the purge members 11 and in a lower portion of the depth of the cooling station. The cooling process is started when lot processing is commenced but the starting of the cooling process is not limited to start of lot processing. The cooling process may be started when wafers 8 are conveyed over the stage 15 or when already ashed wafers 8 are conveyed into the lock chambers 4. The lot processing means that all or a prescribed number of wafers 8 accommodated in at least one cassette 7 are processed.

Then, the wafers 8 cooled to 30° C. or room temperature (25° C.) are taken out of the cooling station 6 by the second transfer robot 5-2 in the atmospheric-pressure transport unit 5-1 and accommodated into the cassette 7, thus completing the processing of the wafers 8. The operations described so far are repeated until ashing of all the wafers 8 previously received in the cassette 7 is completed. The cooling process of the vacuum processing apparatus is under control of a controller 31.

In the above-described vacuum processing apparatus, wafers 8 heated to high temperatures are received in the cassettes 7 after cooled down to 30° C. or room temperature (25° C.) in the cooling station 6 and, therefore, contamination due to gases released from the cassette 7 by the heat brought in from the wafers 8 and thermal deformation of the cassette 7 can be prevented. Consequently, efficient ashing process and efficient cooling process can be achieved at the same time. Furthermore, if a cooling means (not shown) is mounted in each lock chamber 4, two-stage cooling using the lock chambers 4 and the cooling station 6 can be performed. Hence, the wafer 8 can be cooled down to 30° C. or room temperature (25° C.) by holding the wafer in close proximity to the stage 15 over the stage 15 in the cooling station 6 for 10 to 70 seconds. Thus, concentration of thermal stress in the wafer 8 due to rapid temperature variations can be suppressed without deteriorating the efficiency of the ashing process performed by the ashing unit 1. In the present embodiment, the number of stages of slots 9 is equal to or greater than the number of vacuum chambers (the ashing units 1 in the present embodiment). In order to further improve the efficiency of the cooling process performed in the cooling station 6, the number of stages of slots 9 can be set equal to or greater than the number of wafers 8 accommodated in the cassette 7.

Furthermore, in the present embodiment, each vacuum chamber performs an ashing process. Where the vacuum chamber performs a plasma etch process, it is unlikely that the temperature of each wafer does not rise to 300° C. if it is thermally processed. Therefore, it is anticipated that higher cooling effect will be obtained than when an ashing process is performed. Additionally, in the description of the present embodiment, an example of ashing performed at 300° C. is taken. The advantages of the present invention are augmented with lowering the ashing temperature away from 300° C.

In the description of the present embodiment, the processing performed by each vacuum chamber is an ashing process. The present embodiment is effective in other high-temperature processing such as plasma etching and CVD, in which case the same advantages as the advantages of the present embodiment can be derived. Since the vacuum processing apparatus of the present embodiment is not equipped with the cooling units 3, the vacuum chambers that can be connected with the vacuum transport chamber 2-1 can be made larger in number than in the vacuum processing apparatus of Embodiment 1. In consequence, the vacuum processing apparatus of the present embodiment can provide improved efficiency of high-temperature processing per vacuum processing apparatus such as ashing, plasma etching, and CVD as compared with the vacuum processing apparatus of Embodiment 1.

If the cooling station 6 is equipped with a means for conveying wafers to the cooling station 6 and with a cassette placement means over which a cassette accommodating wafers therein are placed, the cooling station 6 of the present invention can be applied to other processing apparatus in order to cool wafers that have been processed at high temperatures in other processing apparatus.

It should be further understood by those skilled in the art that although the foregoing description has been made on embodiments of the invention, the invention is not limited thereto and various changes and modifications may be made without departing from the spirit of the invention and the scope of the appended claims.

1. A vacuum processing apparatus comprising:
a cassette stage on which a cassette having plural samples accommodated therein is placed;
an atmospheric-pressure transport chamber for conveying the samples;
lock chambers that accommodate the samples conveyed in from the atmospheric-pressure transport chamber and have an ambient capable of being switched between an atmospheric ambient and a vacuum ambient;
a vacuum transport chamber coupled to the lock chambers;
at least one vacuum chamber for processing the samples conveyed in via the vacuum transport chamber; and
cooling units disposed in the atmospheric-pressure transport chamber and operable to cool the high-temperature samples processed by the vacuum chamber;
wherein each of the cooling units has a sample stage over which the high-temperature samples are placed and which has a coolant channel, an inlet/exit port through which the samples are conveyed in and out, gas-blowing tubes disposed on a side of the inlet/exit port and acting to blow gas toward the sample stage, and an exhaust port disposed on an opposite side of the sample stage with regard to the inlet/exit port and acting to exhaust the gas blown from the gas-blowing tubes.

2. The vacuum processing apparatus of claim 1, further comprising a transfer robot for conveying the samples into and out of said cooling units;
wherein said sample stage has a section cut out into the same shape as a holding portion of the transfer robot holding the samples and sample placement sections over which the samples conveyed in by the transfer robot are placed; and
wherein said cooling units cool the high-temperature samples while holding the samples in close proximity to the sample stage.
